(19) United States
(12) Patent Application Publication
(10) Pub. No.: US 2002/0073007 A1
(43) Pub. Date: Jun. 13, 2002

(54) System, method, and computer program product for use of lattices in valuating options

(76) Inventor: Elie Ayache, Paris (FR)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/810,623

(22) Filed: Mar. 19, 2001

Related U.S. Application Data
(63) Continuation-in-part of application No. PCT/IB00/01120, filed on Aug. 14, 2000.
(60) Provisional application No. 60/148,318, filed on Aug. 11, 1999.

(51) Int. Cl. G06F 17/60

(52) U.S. Cl. 705/36

(57) ABSTRACT

A system, method, and computer program product for pricing options which involve more than one underlying asset. The method employs a lattice approach by extending current trinomial techniques to higher dimensions, while achieving a maximum economy of nodes. Such economy produces computational advantages in terms of faster execution speed and the utilization of less memory resources. The method valuates options under a general form (i.e., Brownian motion) where parameters may depend on time and price, and accounts for drift and volatility parameters.

### CROSS-REFERENCE TO RELATED APPLICATIONS

This application claims priority to International Patent Application No. PCT/IB00/01120, filed Aug. 14, 2000, which claims priority to U.S. Provisional Patent Application Serial No. 60/148,318, filed Aug. 11, 1999.

### BACKGROUND OF THE INVENTION

1. Field of the Invention

The present invention relates generally to the valuation of financial instruments and more particularly to numerical methods for valuing stock options.

2. Background Art

Within the financial arts, an “option” is widely known as a contract that represents the right to buy or sell a specified amount of an underlying security at a specified price within a specified time. Once the contract is executed, the purchaser acquires a right, and the seller assumes an obligation. The underlying security (i.e., the subject of the option contract) can be, for example, stocks, bonds, futures, interests in real estate, commodities, etc. It is also not uncommon for the option to be underlain with more than one security (e.g., an option on a “basket” of different stocks).

An option is termed a “call” option if the contract gives the purchaser a right to buy the security at the specified price within the specified time. Alternatively, an option is termed a “put” option if the contract gives the purchaser a right to sell the security at the specified price within the specified time. The option contract's specified price is termed the “strike price,” while the option contract's specified time is termed the “maturity date.”

In the case of a call stock option, the purchaser is guaranteed, at maturity, the ability to purchase the specified stock at the strike price. Thus, if the stock's market price at maturity were to be higher than the strike price, the seller (i.e., the party who sold the stock option) would have to pay the difference. If the buyer notices, at maturity, that the stock price in the open market is lower than the strike, the option will simply be allowed to expire unexercised. Alternatively, a put stock option guarantees the option holder the ability, at maturity, to sell the stock at the strike price, thus insuring against a future fall in the stock's price.

Within the world financial markets, it is important to mention one more distinction among options--there are American options and European options. An American option allows the holder to exercise the contract's rights anytime before the maturity date, whereas a European option can only be exercised at the maturity date. American-type options are those most popularly traded.

Given the above discussion, one can see how an option may serve as a form of insurance. The seller of the option (also referred to as the writer of the option) plays the role of the insurer and will ask for a premium to cover its liability. Thus, a problem arises as to exactly how to price an option.

The option pricing problem is that of determining a rational price for the option. That is, determining the premium that a rational buyer (i.e., not one hoping to deceive the insurance company) and a rational seller (i.e., not one ready to take inconsiderate amount of risk) are prepared to agree upon. The comparison of options pricing with insurance policy pricing suggests that the main concerns are estimating the probability of the stock's market price, at maturity, ending up higher or lower than the strike price, and by how much. The problem is further compounded by the fact that there may exist no consensus over such a probability among the parties, and that risk averse investors may value the option much more that those who are not risk averse.

A breakthrough in the problem of options pricing came from the development of a mathematical formula that showed how the rational price of an option could be made independent from any subjective elements—the estimated probability of the stock settling higher or lower, and the utility functions of the investors (i.e., their attitudes towards risk). That mathematical formula, as is now well-known in the relevant art(s), is the Black-Scholes equation. The Black-Scholes equation and model was first introduced in F. Black and M. Scholes, The Pricing of Options and Corporate Liabilities, Journal of Political Economy, 81 (May-June 1973), 637-59, which is incorporated herein by reference in its entirety.

The Black-Scholes formula for determining the price of a call option, C, using the five parameters essential to the pricing of an option: (1) the strike price K; (2) the time to expiration t, (3) the underlying security price S; (4) the volatility of the commodity σ(“sigma”); and (5) the prevailing risk-free interest rate r (the risk-free rate is the rate the safest bank deposit would earn or typically the rate of a U.S. government T-bill), is shown in EQUATION (1):

C=S* N(d₁)−Ke^{-(rt}*N(d₂) (1)

As will be apparent to one skilled in the relevant art(s), e is the exponential function—the inverse of the natural logarithm 1n—that is equal to, up to four significant decimal places, 2.7183. The variables d₁ and d₂ within EQUATION (1) are expressed as shown in EQUATIONS (2A) and (2B), respectively:

$${d}_{1} = \frac{ln ( \frac{S}{K} ) + {( r + \frac{{σ}^{2}}{2} )}^{t}}{σ \sqrt{t}} \qquad \text{(2A)}$$

d₂=d₁−σ\sqrt{t} (2B)

The function “N( )” is the cumulative standard normal distribution function, which is well known in the relevant art(s).

Having presented the Black-Scholes formula for a call option, EQUATION (3) describes the expression for the price P of a put option:

P=C−S+Ke^{-(rt)} (3)

Inherent in the Black-Scholes formulation is the assumption that the writer of the option (e.g., the call seller) will hedge his liability by buying a certain amount of the stock(s) underlying the option prior to any price rally. This assures the writer will be able to simply hand over the stock(s) to the buyer at the maturity of the contract. The difficulty of course is that the option seller cannot foretell the movement of the stock during the life of the option contract. The seller will naturally like to avoid holding stock(s) that no other party—least of all the option buyer—would desire to purchase should the share prices plummet at maturity. Thus, the writer must constantly monitor the evolution of the shares, gradually getting rid of the initial hedge if prices are seen to go down, or gradually building up the hedge if prices are seen to go up. This scheme is often termed a “replication strategy” or “dynamic hedge program.” Therefore, the option seller should account for the replication strategy when setting the price of the option (i.e., ask for an amount of money that the strategy is expected to cost).

As suggested above, of the many factors that impact the price of a stock option, the most relevant is the degree of agitation of the share along its trajectory, which is called its “volatility,” σ. Trajectory, as used herein, refers to a plot of a stock's market price over time. That is, the degree to which the stocks price goes up or down over the course of its trading is most relevant rather than the actual up or down direction of the trajectory, or equivalently, the prior chances that a trajectory has to go up or down. In other words, the actual direction has no impact on the option price. Mathematically this is expressed as follows: Let S be the stock price and dS its variation over an infinitesimal period of time. The infinitesimal percentage return of the stock will then be dS/S.

One cannot tell with certainty how the return of the stock is going to behave over time. One can only tell where one expects the return to be over the next infinitesimal period of time, it being understood that a certain noise, or indeterministic factor, is bound to spoil one's expectation. In other words, the temporal evolution of the return will include two parts: a deterministic part, called the “drift” that represents one's expectation about the future infinitesimal movement, and an indeterministic part that represents the amount of error that one will be found to have committed in reality. The return can then be expressed using EQUATION (4):

$$\frac{d S}{S} = μ d t + σ d Z \qquad ( 4 )$$

where, μdt is the expected return over the infinitesimal period of time, and σdz is the infinitesimal error. Return can be thought of as a moving object (e.g., a rocket), whose instantaneous projected speed is μ, and whose fluctuation around its projected trajectory is accounted for by σdz.

The main issue in theoretically modeling such a trajectory will be one of modeling the error term. As is usually the case when the sources of error and uncertainty are many, and they are many in the case of stocks and financial markets in general, the assumption one makes is that those errors are normally distributed. In other words, the assumption behind the Black-Scholes model is that return will be distributed, over the next infinitesimal period of time, according to a “bell curve,” with mean μdt and standard deviation σ\sqrt{dt} as shown in FIG. 1. The evolution of the return of the stock, when modeled in this fashion is termed Brownian motion (i.e., a phenomenon of constant erratic motion which may be mathematically modeled) by those skilled in the relevant art(s).

The greater the volatility parameter, σ, the greater the dispersion of the return around its expected value, the greater the jaggedness of the corresponding overall trajectory, and thus, the greater the difficulty to track the share price. Also, the instantaneous expected return (or drift) parameter, μ, governs the overall trend of the trajectory. Thus, the greater the drift, the higher prices should be expected to go. Conversely, the smaller the drift (it could of course turn negative), the lower prices should be expected to go.

When investors expect a share to perform well, (i.e., when they assign a greater probability to its trajectory going up rather than down), it is the drift parameter, μ, that they are predicting. The Black-Scholes formulation has shown is that μ is irrelevant to the option pricing problem. Only the volatility, σ, which measures the more or less orderly way in which the share will follow the investors' expectations, will affect the option price. The mathematical reasoning for this is given below.

Because the state variables are the stock price S and time t, one would expect the option price C to be function of S and t as shown above in EQUATION (1). This relationship is given more simply by the expression C(S, t).

When a function has a stochastic variable following the above Brownian motion as one of its state variables, Ito's rule for stochastic differentiation states that the differential of C is given by EQUATION (5):

$$d C = ( \frac{\partial C}{\partial t} + μ S \frac{\partial C}{\partial S} + \frac{1}{2} {σ}^{2} {S}^{2} \frac{{\partial }^{2} C}{\partial {S}^{2}} ) d t + σ S \frac{\partial C}{\partial S} d Z \qquad ( 5 )$$

The Black-Scholes hedge assumption then amounts to noting that if a certain amount, Δ, of the share were held with the option as a hedge against adverse movements of the share, the resulting portfolio:

II=C+ΔS

will yield the following return over the infinitesimal period of time shown in EQUATION (6):

dII=dC+ΔdS (6)

Hence, EQUATION (7), owing to the expression of dS given by the Brownian motion:

$$d Π = ( \frac{\partial C}{\partial t} + μ S \frac{\partial C}{\partial S} + \frac{1}{2} {σ}^{2} {S}^{2} \frac{{\partial }^{2} C}{\partial {S}^{2}} + Δ S μ ) d t + ( σ S \frac{\partial C}{\partial S} + Δ σ S ) d Z \qquad ( 7 )$$

The Black-Scholes formulation then notes that if Δ were chosen equal to

$$- \frac{\partial C}{\partial S} ,$$

the indeterministic component of dII would vanish, and EQUATION (7) would simply be expressed as EQUATION (8) (the term involving μ, has also dropped off):

$$d Π = ( \frac{\partial C}{\partial t} + \frac{1}{2} {σ}^{2} {S}^{2} \frac{{\partial }^{2} C}{\partial {S}^{2}} ) d t \qquad ( 8 )$$

No indeterministic noise would consequently threaten the growth of portfolio II. In other words, II would become a riskless portfolio. A simple arbitrage argument then establishes that II would then have to grow at the riskless rate of interest r (the interest rate that the safest bank deposit would earn). Otherwise, supposing that II grows at a rate greater than r one could borrow money at the rate r, invest it in the riskless portfolio II, and earn the riskless difference. Else, if II grows at a rate smaller than r, one could short sell the portfolio II , deposit the proceeds in the bank account earning r, and also make a riskless profit. Consequently the following must be true:

dII=rIIdt

hence EQUATION (9):

$$\frac{\partial C}{\partial t} + \frac{1}{2} {σ}^{2} {S}^{2} \frac{{\partial }^{2} C}{\partial {S}^{2}} = r C + r Δ S = r C - r \frac{\partial C}{\partial S} S . \qquad ( 9 )$$

Finally, C(S, t) must verify the following differential EQUATION (10):

$$\frac{\partial C}{\partial t} + r \frac{\partial C}{\partial S} S + \frac{1}{2} {σ}^{2} {S}^{2} \frac{{\partial }^{2} C}{\partial {S}^{2}} = r C \qquad ( 10 )$$

The Black and Scholes option pricing formula is an analytical solution of the partial differential EQUATION (10). S and t are the state variables (i.e., it is with respect to them that the partial differentiation is taken), and σ and r are the sole parameters. No trace is left of the expected return μ and its underlying probability or utility estimations.

The option pricing problem, however, admits of a probabilistic interpretation. Because the Black and Scholes argument has established that the option price does not depend on the investors' subjective preferences, estimations of probability, and/or attitudes towards risk, the option price will, in particular, be the price that would have obtained had such preferences and attitudes to risk never existed in the first place. In other words, if all the investors were neutral to risk (a hypothetical world which is labeled the “risk-neutral world” in the relevant art(s)), the option price would nevertheless be the same. The only difference between such a risk neutral world and the actual world, would be that investors would not expect the shares to grow at a rate higher than their risk-free rate investments (e.g., a safe bank deposit). Because these investors are indifferent to risk, they would not ask for a premium for holding a risky share. Hence the evolution of the return of the shares in the risk-neutral world will be simply given by the following stochastic process of EQUATION (11):

$$\frac{d S}{S} = r d t + σ d Z \qquad ( 11 )$$

In view of such a process, one would only need to estimate the value of σ to be able to draw realizations of the Brownian paths such as the ones drawn above, for the interest rate r is known. Every such realization will produce a different “hit” S_{T} (i.e., a different final stock price) at the maturity of the option. Remembering that the call option pays at maturity the difference between S_{T} and the strike price, K if S_{T} is greater than K, else zero, and noting that (S_{T}−K)⁺ the payoff (i.e., (S_{T}−K)⁺=max(S_{T}−K,0)), one may compute the expected value of the option payoff using EQUATION (12):

$$E ( payoff ) = {\sum }_{all paths} {{prob}_{path} ( {S}_{T} - K )}^{+} \qquad ( 12 )$$

where the summation is taken over all the paths that the Brownian motion of EQUATION (11) can generate.

Stochastic calculus establishes that the solution of the partial differential EQUATION (10) above (i.e., the price of the option), can be represented as the discounted expected value of the option payoff under the Brownian motion of EQUATION (13):

$$C = {ⅇ}^{- r T} {\sum }_{all paths} {{prob}_{path} ( {S}_{T} - K )}^{+} \qquad ( 13 )$$

Thus, there are two different methods of computing the price of an option, either solve the partial differential EQUATION (10), or compute expected values under all possible paths using EQUATION (13).

Difficulties, however, prevent the option pricing problem from being as simple as it first seems. The Black-Scholes analytical solution is valid only when the interest rate r and the volatility parameter σ are constant. One may be interested in pricing options under a more general Brownian motion such as EQUATION (14):

$$\frac{dS}{S} = r ( S , t ) dt + σ ( S , t ) dZ \qquad ( 14 )$$

where the parameters now themselves depend on time and the stock price. A great deal of the literature in the relevant art(s) that followed Black and Scholes' 1973 paper has studied the option pricing problem under these more general assumptions. No analytical solutions, however, are generally available when the stochastic process is given by EQUATION (14), So one has to resort to a numerical resolution of the partial differential EQUATION (10). Alternatively, one can attempt to compute expected values. The only difficulty in that case is that the number of paths generated by a Brownian motion is infinite. Thus, one cannot practically take summations over all paths. One may choose to select a finite number of representative paths to perform the summation—a process known as “discretization” of the stochastic process.

Thus, two different schools of option researchers exist. Those who would rather numerically solve the partial differential EQUATION (10), and those who would rather seek a discretization of the driving stochastic process—known as the “tree” or “lattice” approach. The tree or lattice approach, however, is better suited to the option pricing problem because it can accommodate not only European options easily (like the Black-Scholes model), but can easily handle American options as well.

Therefore, what is needed is a system, method, and computer program product that solves the option pricing problem while accounting for drift and volatility parameters of the most general form (i.e., EQUATION (14)). The system, method, and computer program product should use the lattice approach and handle the case where the number of dimensions is greater than one (i.e., when there is more than one stochastic process underlying the option). The system, method, and computer program product should also seek the most economical and efficient lattice discretization and thus, achieve the maximum economy in terms of computing time and resources.

### BRIEF SUMMARY OF THE INVENTION

The present invention is a system, method, and computer program product for use of lattices in valuing options. More specifically, the method prices the current value of an option consisting of a plurality of underlying assets (i.e., a basket option). The method includes the steps of receiving inputs indicative of the spot value of the underlying assets and the diffusion parameters. The diffusion parameters include the correlation, ρ, of each asset to each other asset within the basket, and the volatility, σ, of each of the plurality of assets. Then, inputs indicative of the risk free interest rate, r; the drift function, μ(X, t), and the probability parameter, p are received.

The method further includes receiving inputs indicative of the desired time slices and the maturity date of the option. Then a lattice is constructed using the constant parameters, wherein the lattice is comprised of an elementary lattice cell structure for each of the time slices. Once the lattice is constructed, it is traversed, in a backwards fashion, in order to calculate the value of the option from said date of maturity to the present.

One advantage of the present invention is that it can calculate the price of any contingent claim that is underlain by two or three driving Brownian motions (i.e., the pricing of spread and basket options), the pricing of options and convertible bonds under stochastic interest rates, the pricing of interest rate derivatives when two or three stochastic factors govern the evolution of the yield curve, etc.

Another advantage of the present invention is that it can be used as a tool in managing a portfolio of multi-factor options, and assessing (at all times and in all market conditions) the value of the options. The present invention can also assists in the hedging and re-hedging (at all times) of a portfolio. That is, buying and selling orders of the underlying shares or other liquid market instruments can be generated in order to achieve neutrality with respect to adverse market movements.

Another advantage of the present invention is that it can assists in the assessment of risks of options held in a portfolio by providing an evaluation of hypothetical losses (or gains) that the portfolio incurs on sudden (or gradual) market and volatility shifts.

Yet another advantage of the present invention is that, more generally, it serves any purpose that would require the discretization of two or three-dimensional Brownian motions with general drift and volatility parameters (e.g., physicists interested in the random motion of a particle in 3D space can utilize the lattices of the present invention as an efficient illustration of that motion, etc.).

Further features and advantages of the invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a diagram illustrating a standard bell curve;

FIG. 2 is a diagram illustrating a Cox tree showing the constant size paths representing up and down movements of a stock price;

FIG. 3 is a binomial lattice showing the constant size paths representing up and down movements of a stock price;

FIG. 4 is a binomial lattice showing the evolution of the stock price over a single time interval;

FIG. 5 is a binomial lattice showing the corresponding binomial fork of a stock price is the discounted expected value of its two terminal values;

FIG. 6 is a tree illustrating the call price of a stock option payoff at maturity;

FIG. 7 is a trinomial tree illustrating variable drift and volatility parameters;

FIG. 8 is a trinomial Hull and White lattice illustrating the permutations for a basket option containing two assets;

FIG. 9 is a flowchart representing the lattice creation process according to an embodiment of the present invention;

FIG. 10 is a flowchart representing the lattice traversal process according to an embodiment of the present invention;

FIG. 11 is a diagram of an integer hexagon produced according to an embodiment of the present invention;

FIG. 12 is a diagram of an physical hexagon produced according to an embodiment of the present invention;

FIG. 13 is a diagram of a rhombic dodecahedral lattice produced according to an embodiment of the present invention;

FIG. 14 is a block diagram of an example computer system useful for implementing the present invention;

FIG. 15 is a rhombic dodecahedron produced according to an embodiment of the present invention; and

FIG. 16 is a the nucleus of the rhombic dodecahedron (Lord Kelvin's solid) produced according to an embodiment of the present invention.

### DETAILED DESCRIPTION OF THE INVENTION

### Table of Contents

I. Overview

II. The Lattice Approach

A. The Binomial Lattice

B. The Trinomial Lattice

III. The Model: PI's Extension of the Lattice Approach

IV. Example of System Operation—Lattice Creation

V. Example of System Operation—Lattice Traversal

VI. Details of Lattice Geometry—Two Dimensional Case

A. Inputs

B. Determination of the Geometry of the Elementary Cell

C. Building of the Lattice

D. Traversing the Lattice

VII. Details of Lattice Geometry—Three Dimensional Case

A. Inputs

B. Determination of the Geometry of the Elementary Cell

C. Building of the Lattice

D. Traversing the Lattice

VIII. Computational Efficiency of the Present Invention

IX. Example Implementations

X. Conclusion

I. Overview

The present invention is directed to a system, method, and computer program product for use of lattices in valuing options. For example, the method allows the pricing of options where more than one asset is involved (i.e., a basket option). In an embodiment, the present invention is provided as a tool to users (either individuals or members of a trading firm) interested in valuing such options.

In an alternate embodiment of the present invention, a trading organization may provide a brokerage desk that facilitates option trades for clients as well as providing an interactive World-Wide Web site accessible via the global Internet for pricing model and trade execution services. Such an infrastructure may be an organized exchange for options.

The present invention is described in terms of the above example. This is for convenience only and is not intended to limit the application of the present invention. In fact, after reading the following description, it will be apparent to one skilled in the relevant art(s) how to implement the following invention in alternative embodiments (e.g., valuing other financial instruments or, more generally, illustrating any Brownian motion).

II. The Tree and Lattice Approach

A. The Binomial Lattice

The first, simplest lattice was devised by Cox, Ross and Rubinstein as described in J. C. Cox et al., Option Pricing: A Simplified Approach, Journal of Financial Economics, 7, (October1979), 229-63, which is incorporated herein by reference in its entirety. It assumes that the drift parameter, μ, and volatility parameter, σ, are constant, and therefore only improves the Black-Scholes formulation with respect to the pricing of American options.

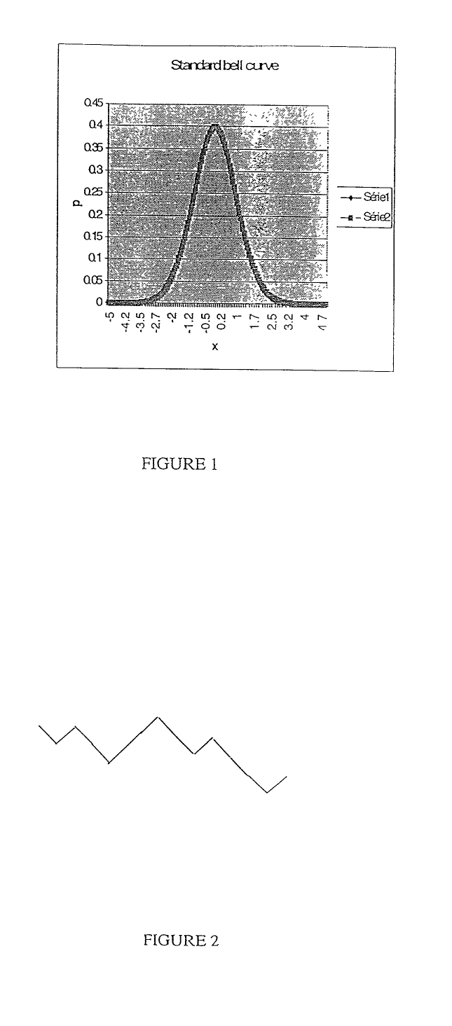

The Cox tree further assumes that the stock is allowed to move in finite intervals of time, and selects among all possible paths only those that can be represented as an arbitrary concatenation of up and down movements of constant size as shown in FIG. 2. If the life span of the option is sliced into n equal time intervals, there will be a total of 2″ such possible “discrete” paths.

Supposing that the probability of an elementary up movement is p and that of an elementary down movement is (1−p), the probability of any one path is given by EQUATION (15):

π(path)=IIp^{k}(1−p)^{n-k} (15)

where k is the number of up jumps taking place over the whole path. This suggests that the option price, computed as the discounted expected value of its payoff, will have to be a sum of 2″ terms as shown in EQUATION (16):

C=e^{-rT}ΣIIp^{k}(1−p)^{n-k}(S_{T}−K)⁺ (16)

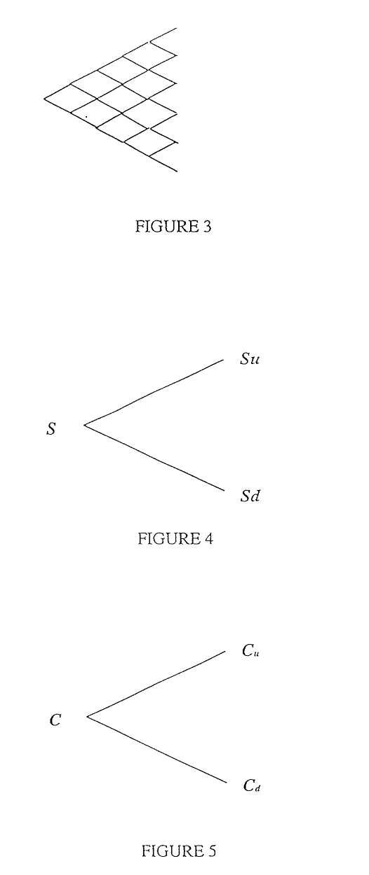

This calculation, however, turns out to be much simpler. If one were to draw the grid underlying all possible paths, one would obtain a lattice, called a “binomial lattice” as shown in FIG. 3. Owing to the regularity and symmetry of the lattice, the final possible values of the stock will be known beforehand, and so would the possible option payoffs.

Computing the option price will then proceed recursively in the following fashion. Calling u and d, respectively, the sizes of the elementary up and down movements, the evolution of the stock price over a single time interval can be pictured as shown in FIG. 4.

Requiring that the binomial lattice be an approximation of the Brownian motion with drift parameter μ and volatility parameter σ can be shown to impose EQUATIONS (17) and (18)

pu+(1−p)d=e^{rdt} (17)

pu²+(1−p)d²=σ²dt+e^{2rdt} (18)

where dt is the size of the finite time interval. EQUATIONS (17) and (18) are called, respectively, the first moment and second moment equations. Assuming that d=1/u, this yields the approximate solution to EQUATIONS (17) and (18):

$$u = {ⅇ}^{σ \sqrt{dt}}$$

$$d = {ⅆ}^{- σ \sqrt{dt}} \\ p = \frac{{e}^{rdt} - d}{u - d}$$

Because the option price C in the corresponding binomial fork is the discounted expected value of its two terminal values as shown in FIG. 5, this yields EQUATION (19):

C=e^{-rdt}[pCᵤ+(1−p)C_{d}] (19)

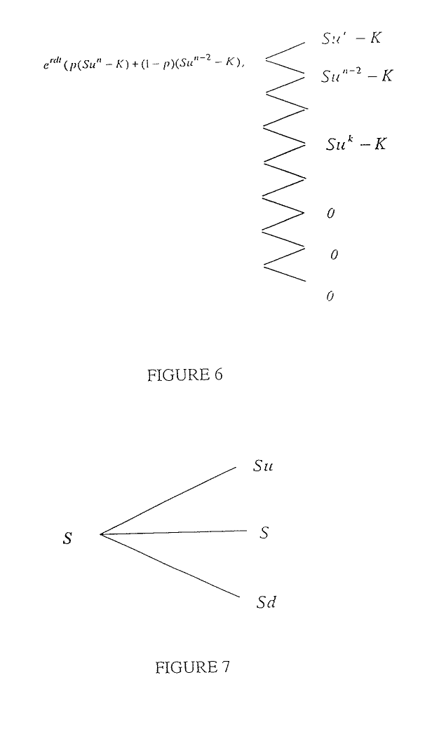

In order to compute the call price in the full-blown lattice, one has to express the option payoff at maturity as shown in FIG. 6 and then roll back towards the origin of the lattice, computing the option value at each node as the discounted expected value of the corresponding binomial fork. As the total number of nodes of a binomial lattice is:

$$\frac{( n + 1 ) ( n + 2 )}{2}$$

and the value at each node is only the sum of two terms, the summation is far less than the dreaded summation of 2″ terms as in EQUATION (16).

Despite its simplicity, the binomial lattice has drawbacks. The expressions of u, d, and p above are only approximate. The exact values are functions of both the drift and the volatility. So one could not accurately discretize a Brownian motion with varying drift and volatility coefficients without altering the values u, and p throughout the lattice. This would alter its simple structure.

The Trinomial Lattice

One alternative, when the drift and volatility parameters are required to be variable, is the trinomial lattice. The trinomial lattice, as its name suggest, has three branches emanating from each node. Calling u, d, and m, respectively, the sizes of the elementary up, down, and middle movements, the evolution of the stock price over a single time interval can be shown in FIG. 7 (compare to FIG. 4). Thus, the transition probabilities are now pᵤ, p_{d}, and pₘ, where pₘ=1−pᵤ−p_{d}.

This provides an extra degree of freedom which allows u and d to remain constant throughout the lattice, while the probabilities solve the first and second moment equations and account for the varying character of the drift and volatility parameters:

$$u = {ⅇ}^{σ \sqrt{3 dt}}$$

$$d = \frac{1}{u}$$

$${p}_{u} = \sqrt{\frac{dt}{12 {σ}^{2}}} ( r - \frac{{σ}^{2}}{2} ) + \frac{1}{6}$$

$${p}_{m} = \frac{2}{3}$$

$${p}_{d} = - \sqrt{\frac{dt}{12 {σ}^{2}}} ( r - \frac{{σ}^{2}}{2} ) + \frac{1}{6}$$

(See Hull, John, Options, Futures, and Other Derivative Securities, Third Edition, Prentice Hall (Englewood Cliffs, N.J), 1997, ISBN 0138874980, p. 360, which is incorporated herein by reference in its entirety.)

In Hull and White, Branching Out, RISK, July 1994, which is incorporated herein by reference in its entirety, the use of trinomial lattices was first promoted. Moreover, they were the first to solve the problem of negative probabilities (p_{d} can turn negative if μ is sufficiently large) by the alternative branching technique which the present invention addresses.

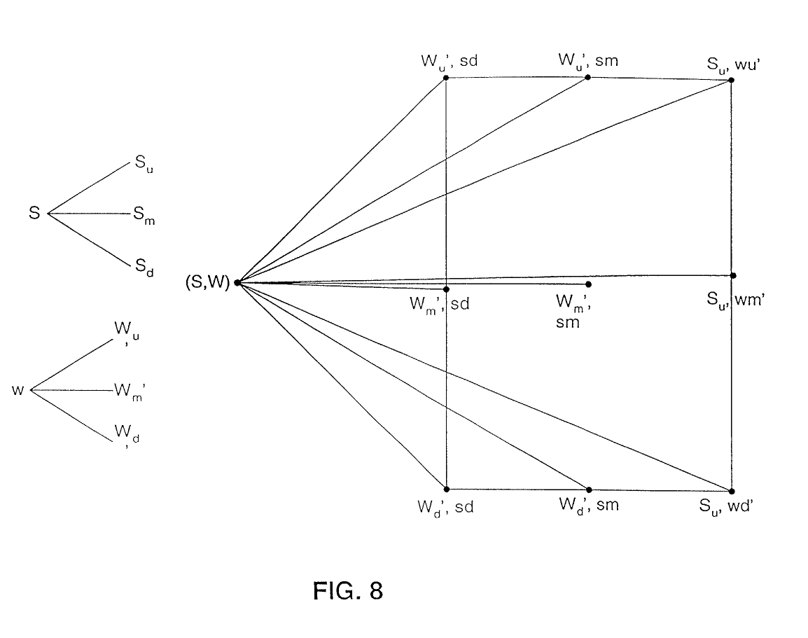

Also, when more than one stochastic variable is underlying the option, Hull and White simply suggested to take the tensor product lattice, which is not the most efficient. For example, consider an option on a basket of two stocks S and W. Hull and White recommends that for each node of the lattice, nine nodes be generated to represent the permutations of each stock going up, down, or remaining the same (i.e., middle). Thus, the Hull and White lattice, in this instance, requires nine probabilities to be calculated at each node. This is illustrated in FIG. 8.

III The Model: Present Invention's Extension of the Lattice Approach

The present invention extends Hull and White's trinomial technique to obtain the most economical and efficient lattice discretization for higher dimensional Brownian motions of the most general form (i.e., EQUATION (14)). Consider TABLE 1, below, which highlights the present invention's efficient computation:

TABLE 1

| | | | PRESENT |
|---|---|---|---|
| | | | INVENTION |
| | | | LATTICE |
| # OF UNDERLYING | HULL & | PRESENT | ELEMENTARY |
| ASSETS IN OPTION | WHITE | INVENTION | CELL |
| BASKET | NODES | NODES | SHAPE |
| 2 | 9 | 7 | Hexagon |
| 3 | 27 | 15 | Rhomba- |
| | | | Dodecahedron |

.
.
.

| | | | |
|---|---|---|---|
| N | 3^{N} | (2^{N+1}) − 1 | (2^{N+1}) − 2 |

Thus, the present invention will produce a hexagonal structure (six nodes plus the middle for a total of seven nodes) in computing the option price of a basket containing two assets. Accordingly, the present invention will produce a rhomba-dodecahedron (fourteen nodes plus the middle for a total of fifteen nodes) in computing the option price of a basket containing three assets. The present invention aims to use a simpler tree than 3ⁿ and assures the probabilities are positive no matter the value of the drift, μ.

IV. Example of System Operation—Lattice Creation

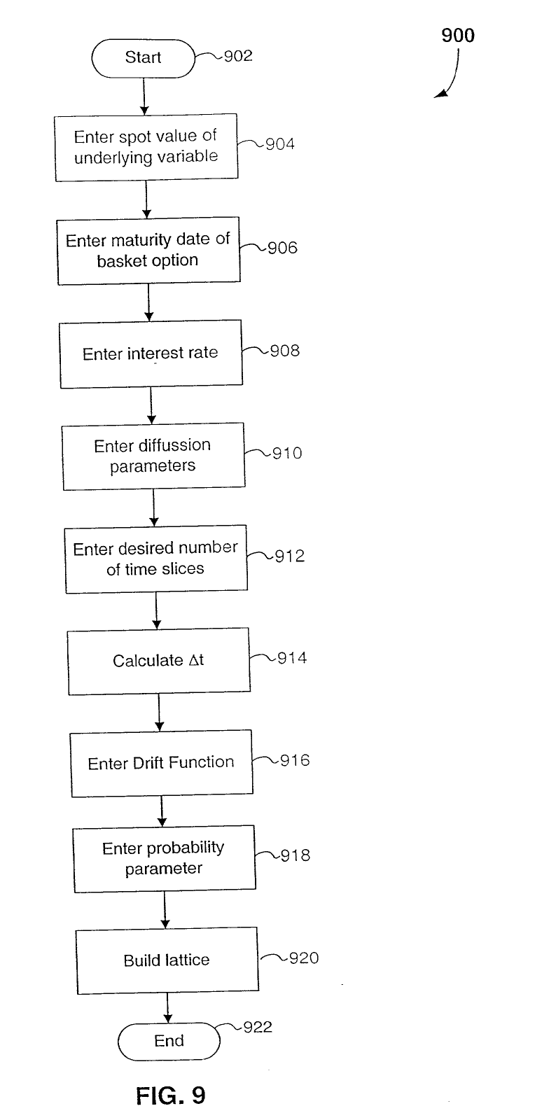

Referring to FIG. 9, a flowchart representing the lattice creation process 900 of the present invention is shown. More specifically, lattice creation process 900 illustrates the case where the present invention is used to price an option on a basket containing multiple assets (e.g. stocks S₁ and S₂—the two asset row of TABLE 1). Lattice creation process 900 begins at step 902 with control passing immediately to step 904.

In step 904, lattice creation process 900 receives inputs representing the spot value of the assets S₁ and S₂. In step 906, the maturity date, T, of the basket option is entered. In an embodiment of the present invention, the maturity date is specified in terms (or a fraction) of a year (i.e., for a six month maturity date, T=0.5). In step 908, the prevailing risk-free interest rate, r, is entered. In step 910, the respective volatility of the underlying assets are entered (e.g., σ₁ and σ₂ for S₁ and S₂, respectively). Also, the correlation, ρ, between each two pairs of assets are entered. These three inputs are collectively known as the “diffusion parameters.”

In step 912, the number of time slices, N, the life span of the option is sliced into equal time intervals is entered. As will be apparent to one skilled in the relevant art(s), the greater the value of N, the more accurate the discretization (i.e., greater the accuracy of the present invention), but with the associated increase in computation time and resources. Moreover, as N approaches infinity, the accuracy of the output price of the present invention approaches the accuracy of the Black-Scholes model. In step 914, the value of elementary time step, Δt is calculated, which is T/N.

In steps 916, the drift function, μ(X, t), is entered, and in step 918, the probability parameter, p, is entered.

In step 920, the lattice specified in TABLE 1 is generated using a recursive procedure going forward. For example, in the case of an option basket of two underlying assets, the lattice generated in step 920 would be an initial node (the “origin” or “root”) which generates an initial hexagon. Each node of the initial hexagon would then recursively spawn another hexagon N times (i.e., the number of time slices entered). Each of the seven nodes generated by the probability distribution function (e.g., see EQUATION (31) as explained in detail below). Lattice creation process then ends as indicated by step 922.

V. Example of System Operation—Lattice Traversal

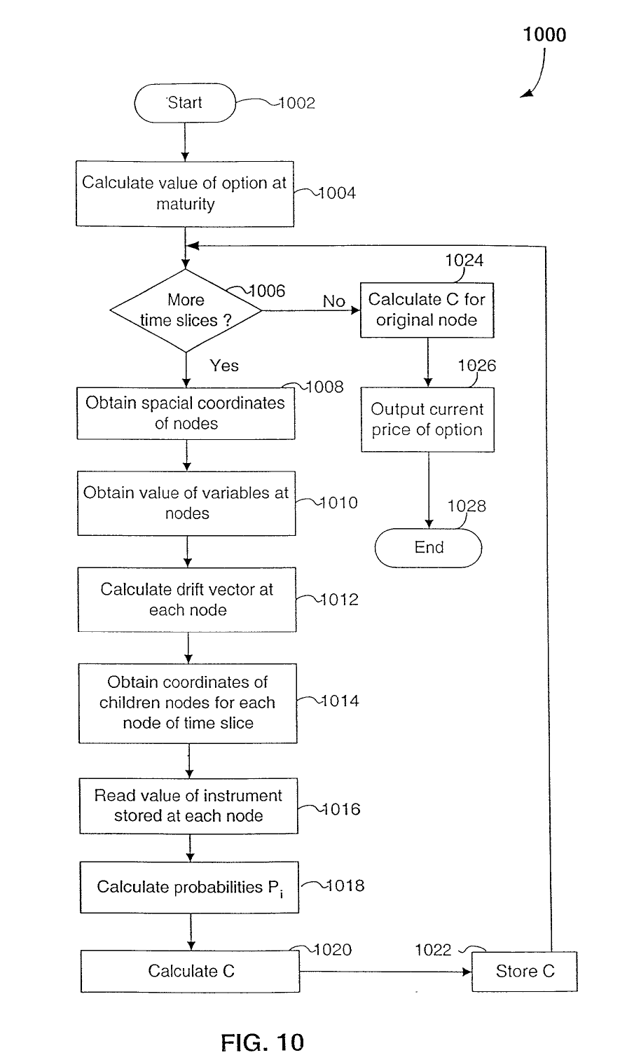

Referring to FIG. 10, a flowchart representing the lattice traversal process 1000 of the present invention is shown. More specifically, lattice traversal process 1000 illustrates the case where the present invention is used to price an option on a basket containing multiple assets (e.g. stocks S₁ and S₂). That is, process 1000 traverses the lattice created by process 900 explained above with reference to FIG. 9. Lattice traversal process 1000 begins at step 1002 with control passing immediately to step 1004.

Once the lattice is created as shown in FIG. 10, there exist a record, for each time slice, of the nodes which constitute that time slice. Thus, in step 1004, the value at maturity of the option (time slice t=N) is calculated. Next, the value of the option at every time slice (t=N−1, −2, . . . , 0) can be calculated using the following steps 1008-1026 as indicated by step 1006. In step 1008, the spacial coordinates for each of the nodes of a time slice's lattice structure (e.g., the seven nodes of the hexagon for a basket option of two assets) is obtained. In step 1010, the value of the assets (e.g., S₁ and S₂) are calculated at each of the nodes. In step 1012, the drift vector, μ, is calculated at each node using the drift function inputted in step 916 of lattice creation process 900.

In step 1014, the coordinates of the children of each node is obtained. In step 1016, the stored value of the option at each of the children nodes is read. In step 1018, the probabilities for each node are calculated. In step 1020, the option price, C, is calculated for the time slice. In step 1022, the price is stored. This process repeats until no more time slices are left to traverse as indicated by step 1006.

Once all time slices have been traversed and the root node is reached, in step 1024, (time slice t=0), the price, C, for the original node is calculated. In step 1026, the current price of the option is outputted and process 1000 ends as indicated by step 1028.

As will be apparent to one skilled in the relevant art(s), the present invention provides a computational advantage in that when the value at time slice t=n−2 is calculated, the values for time slice t=n may be discarded as they are no longer needed. Thus, when the values for t=n−4 are calculated, the values for t=n−2 are no longer needed, and so forth.

VI. Details of Lattice Geometry—Two Dimensional Case

Having generally described the lattice creation process 900 and lattice traversal process 1000 above, a more detailed description is now given for the case where pricing a basket option which includes two underlying assets is desired. Further, example C++ programming language source code that implements the lattice creation process 900 and lattice traversal process 1000, as described in detail below for the two-dimensional case, is shown in APPENDIX A.

A. Inputs

The first consideration is the two underlying stochastic variables representing each asset in the basket, x₁ and x₂ (e.g., stocks S₁ and S₂ presented above with reference to FIGS. 9 and 10). These two variables form one underlying stochastic vector:

$$X = ( \begin{matrix}{x}_{1} \\ {x}_{2}\end{matrix} )$$

The stochastic processes in the risk-neutral world are:

Cx₁μ₁(X,t)dt+σ₁dz₁

dx₂=μ₁(X,t)dt+σ₂dz₂

with correlation ρ between dz₁ and dz₂. The volatility parameters, σ₁ and σ₂, and the correlation coefficient, ρ, are constant, but the drift vector:

$$μ = ( \begin{matrix}{μ}_{1} \\ {μ}_{2}\end{matrix} )$$

depends on both the state X and time t. The initial state at time t=0 is:

$${X}_{0} = ( \begin{matrix}{x}_{1}^{0} \\ {x}_{2}^{0}\end{matrix} )$$

The present invention aims to price, at time t=0, a contingent claim C (i.e. a derivative instrument whose payoff is contingent upon the underlying vector X), of time to maturity T and payoff at maturity P(X). The price at time t−0, is denoted by C(X₀, 0). If the derivative instrument is an American-type option, its time t, state X, price C(X,t) must verify:

C(X,t)≧I(X)

This is because the function “I( )” is the lower bound of the American-type option. Typically, in the simplest case, this is the intrinsic value of the option (i.e., (S−K), or for convertible bonds, (R * S), where R is the conversion ratio). Optimality in exercising options requires that one check, while traversing the lattice, to ensure that the stored value of the option is always greater than the intrinsic value. If this were not the case, the holder would simply exercise the option, and retain the greater (intrinsic) exercise value. Thus, as described below, the greater of the two values is always stored while traversing the lattice. Hence, exercising the option is optimal in those nodes where the computed value, C, is replaced by the lower bound of the American-type options.

As shown in FIG. 9, inputs of the lattice building process 900 are: (a) the diffusion parameters, ρ, σ, σ₂; (b) the complete drift function:

$$μ ( X , t ) = ( \begin{matrix}{μ}_{1} ( X , t ) \\ {μ}_{2} ( X , t )\end{matrix} )$$

(c) the initial value of the underlying state vector, X₀; (d) the value of the short interest rate r (or the interest rate term structure—yield curve or forward curve); (e) the number of time steps, N, one wishes to take; and (f) the probability parameter p.

As will be appreciated by one skilled in the relevant art(s), the short rate, r, will not be an input if it is itself one of the underlying stochastic variables.

B. Determination of the Geometry of the Elementary Cell

In the two-dimensional (i.e., two stochastic variables) case, the elementary cell is a centered hexagon (see TABLE 1 above). However, it must be geometrically deformed in order to reflect the diffusion matrix:

$$\sum = ( \begin{matrix}{σ}_{1}^{2} & {ρσ}_{1} {σ}_{2} \\ {ρσ}_{1} {σ}_{2} & {σ}_{2}^{2}\end{matrix} ) Δ t$$

The transformation matrix A is:

$$A = \sqrt{\frac{2}{p} P \sqrt{Λ}}$$

where:

(The symbol “*” denotes the transpose of a matrix.) That is, the matrix:

$$Λ = ( \begin{matrix}{λ}_{1} & 0 \\ 0 & {λ}_{2}\end{matrix} )$$

is the matrix of eigenvalues of Σ, and P the matrix of eigenvectors, which are computed by standard techniques. The present invention's lattice (i.e., the set of states or nodes:

$$X = ( \begin{matrix}{x}_{1} \\ {x}_{2}\end{matrix} )$$

retained for the discretization) is a deformed hexagonal lattice. However, a straight computational lattice, E, is defined where coordinates of the nodes have integer values and correspond one to one to the real “physical” nodes:

$$E = ( \begin{matrix}{i}_{1} \\ {i}_{2}\end{matrix} ) ↔ X = ( \begin{matrix}{x}_{1} \\ {x}_{2}\end{matrix} )$$

through the transformation:

$$( \begin{matrix}{x}_{1} \\ {x}_{2}\end{matrix} ) = A ( \begin{matrix}1 & 1 / 2 \\ 0 & \sqrt{3 / 2}\end{matrix} ) ( \begin{matrix}{i}_{1} \\ {i}_{2}\end{matrix} )$$

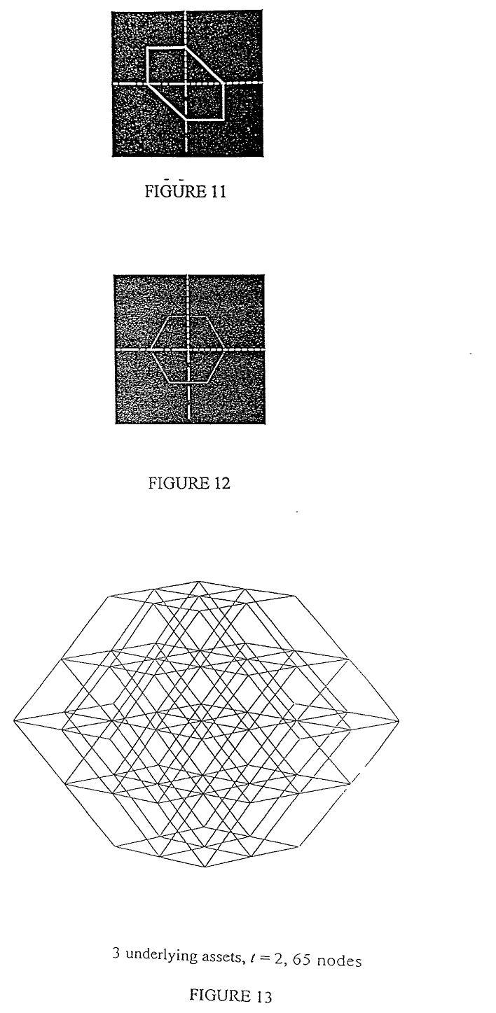

In the computational plane, the hexagon is as shown in FIG. 11. The hexagon of FIG. 11 has vertices having the following integer co-ordinates:

$$( \begin{matrix}1 & 0 & - 1 & - 1 & 0 & 1 \\ 0 & 1 & 1 & 0 & - 1 & - 1\end{matrix} )$$

The “integer hexagon” of FIG. 11 is then transformed into the typical “physical hexagon” shown in FIG. 12 using the following matrix:

$$H = ( \begin{matrix}1 & 1 / 2 \\ 0 & \sqrt{3 / 2}\end{matrix} )$$

The “physical hexagon” shown in FIG. 12 is then further transformed by matrix A to reflect the diffusion parameters.

C Building of the Lattice

The building of the lattice (i.e., step 920 of process 900) is a recursive procedure running forward in time. It starts with the origin (or root):

$${X}_{0} = ( \begin{matrix}{x}_{1}^{0} \\ {x}_{2}^{0}\end{matrix} )$$

and progressively “marks,” for each time slice n (0≦n≦N), the nodes of the computational lattice E which will belong to this time slice. It is the drift function that governs this process. The recursive mechanism can be described by the following five-step process. If nodes of time slice n−1 are given by the following set:

$${E}_{n - 1} = {\{ {E}_{n - 1}^{k} \}}_{1 \leq k \leq {K}_{n - 1}} \qquad ( 20 )$$

where Kₙ₋₁ is the number of nodes, the following steps are performed:

First, for each node, Eₙ₋₁^{k}, its physical correspondent Xₙ₋₁^{k} is found by utilizing EQUATION (21):

Xₙ₋₁^{k}=X₀+AHEₙ₋₁^{k} (21)

(This means the root X₀ has the computational correspondent

$${E}_{0} = ( \begin{matrix}0 \\ 0\end{matrix} ) )$$

Second, the drift vector at Xₙ₋₁^{k}, is computed using EQUATION (22):

$$μ ( {X}_{n - 1}^{k} , ( n - 1 ) Δ t ) = ( \begin{matrix}{μ}_{1} ( {X}_{n - 1}^{k} , ( n - 1 ) Δ t ) \\ {μ}_{2} ( {X}_{n - 1}^{k} , ( n - 1 ) Δ t )\end{matrix} ) \qquad ( 22 )$$

Third, the drift vector directs, by use of EQUATION (23), to a point Zₙ₋₁^{k} somewhere in the physical plane:

Zₙ₋₁^{k}=Xₙ₋₁^{k}+μₙ₋₁^{k} (23)

Fourth, the node of the lattice that is “closest” to Zₙ₋₁^{k} must then be determined. This closest node is termed the “target node”, Yₙ₋₁^{k}. The target node is the candidate node for occupying the center of the cell of descendants of Xₙ₋₁^{k}. This means once the target node is determined, the other six children nodes of Xₙ₋₁^{k} will be determined as well, as vertices of the hexagon surrounding Yₙ₋₁^{k}.

The determining criterion is the point where the drift points to, Zₙ₋₁^{k}, and lies in the nucleus of the target cell (i.e. Yₙ₋₁^{k} must the be the center of the hexagon in whose nucleus Zₙ₋₁^{k} lies). Calling

$$( \begin{matrix}{z}_{1} \\ {z}_{2}\end{matrix} )$$

the physical coordinates of Zₙ₋₁^{k}, its coordinates in the computational plane are given by EQUATION (24):

$$e = ( \begin{matrix}{e}_{1} \\ {e}_{2}\end{matrix} ) = {H}^{- 1} {A}^{- 1} ( \begin{matrix}{z}_{1} - {x}_{1}^{0} \\ {z}_{2} - {x}_{2}^{0}\end{matrix} ) \qquad ( 24 )$$

These will not generally be integer values. However, the four nodes of the computational lattice (i.e., with integer coordinates) which will surround

$$( \begin{matrix}{e}_{1} \\ {e}_{2}\end{matrix} )$$

are desired. These four nodes are given by EQUATION (25):

$$( \begin{matrix}{f}_{1} & {f}_{2} & {f}_{3} & {f}_{4}\end{matrix} ) = ( \begin{matrix}int ( {e}_{1} ) & int ( {e}_{1} ) + 1 & int ( {e}_{1} ) & int ( {e}_{1} ) + 1 \\ int ( {e}_{2} ) & int ( {e}_{2} ) & int ( {e}_{2} ) + 1 & int ( {e}_{2} ) + 1\end{matrix} ) \qquad ( 25 )$$

where int(e₁) is the integer value of e₁.

The target node, Yₙ₋₁^{k}, will be the one among these four nodes that is closest to Zₙ₋₁^{k}. As used herein, “closest” means nearest in terms of Euclidian distance as measured in the intermediary plane where the hexagonal cell is the traditional straight hexagon as depicted in FIG. 12. This is not the physical plane, nor is it the computational plane. Rather, this distance is measured in the plane which is the image by H of the computational plane E. In other words, the ƒ₁ among the four candidates above such that the Euclidian distance given by EQUATION (26) is minimal is chosen:

∥H(e)−H(ƒ₁)∥

The selected ƒ₁ will then represent the coordinates in the computational plane of the sought after target node Yₙ₋₁^{k}. As for the six other children, their coordinates in the computational plane will be given by EQUATION (27):

$${f}_{i} + ( \begin{matrix}1 & 0 & - 1 & - 1 & 0 & 1 \\ 0 & 1 & 1 & 0 & - 1 & - 1\end{matrix} ) \qquad ( 27 )$$

Fifth, the above procedure is repeated for each one of Eₙ₋₁^{k} and discarding repetitions, will produce the list of the nodes of the computational lattice which will constitute time slice n:

$${E}_{n} = {\{ {E}_{n}^{k} \}}_{1 \leq k \leq {K}_{n}} = {⋃}_{1 \leq k \leq {K}_{n - 1}} \{ seven children of {E}_{n - 1}^{k} \}$$

D. Traversing the Lattice

Once the building the lattice is completed, a record for each time slice of the nodes constituting it will exist. More specifically, the complete list of nodes of the last time slice N is available:

$${E}_{N} = {\{ {E}_{N}^{k} \}}_{1 \leq k \leq {K}_{N}}$$

First, the payoff of the derivative instrument is then computed at this last time slice t=N. For each one of the nodes, its physical coordinates are determined by using the EQUATION (21):

$${X}_{N}^{k} = {X}_{0} + {AHE}_{N}^{k}$$

and the corresponding payoff is computed by P(X_{N}^{k}). This is the value of the derivative instrument which will be stored in time slice t=N at node E_{N}^{k}. Rolling back in the tree will then inductively take place as follows.

Assuming values of the derivative instrument have been computed and stored at all nodes Eₙ^{k} of time slice n, step back to time slice n−1. Stored in a record is the list of nodes given by EQUATION (20):

$${E}_{n - 1} = {\{ {E}_{n - 1}^{k} \}}_{1 \leq k \leq {K}_{n - 1}}$$

For each one of these nodes Eₙ₋₁^{k} (whose physical equivalent is Nₙ₋₁^{k}) its seven children nodes are found in the same fashion as when building the lattice (in particular, node Yₙ₋₁^{k} occupying the center of the descendent cell is found). The children will have to figure among the {Eₙ^{k}}_{1≦k≦K}_{ₙ} as this is what building the lattice during process 900 is meant to insure.

Next, the values (Cₙⁱ)_{1≦i≦7} of the derivative instrument that have been previously stored in these seven nodes are retrieved. The drift μₙ₋₁^{k} is cut by the displacement between Xₙ₋₁^{k} and Yₙ₋₁^{k} as shown in EQUATION (28):

$${μ}_{n - 1}^{k} = {μ}_{n - 1}^{k} - ( {Y}_{n - 1}^{k} - {X}_{n - 1}^{k} ) \qquad ( 28 )$$

All of the above steps are performed in the physical plane.

Next, the residual drift on the transformed basis is decomposed to obtain

$$( \begin{matrix}α \\ β\end{matrix} )$$

by using EQUATION (29):

$$( \begin{matrix}α \\ β\end{matrix} ) = {A}^{- 1} {μ}_{n - 1}^{k} \qquad ( 29 )$$

The value of the derivative instrument which is to be stored in time slice n-1 at node Eₙ₋₁^{k} is first evaluated by EQUATION (30):

$${C}_{n - 1}^{k} = {e}^{- {r}_{n - {1}^{Δ t}}^{k}} {\sum }_{1 \leq i \leq 7} {p}_{i} {C}_{n}^{i} \qquad ( 30 )$$

where rₙ₋₁^{k} is the instantaneous interest rate prevailing at node Xₙ₋₁^{k} in time slice n−1 (if the short rate is among the underlying stochastic variables, rₙ₋₁^{k} will be one of the components of Xₙ₋₁^{k}, otherwise it is uniform within the same time slice and equal to the forward rate as given by the initial input of the forward curve). (pᵢ)_{1≦i≦7} are the guaranteed positive risk-neutral probabilities (i.e. the probabilities that ensure that first and second moment equations of the risk-neutral stochastic processes given above are matched at each node). If the seven children nodes are listed in the same order as the coordinates of the hexagon above, the probabilities are given by EQUATION (31)(a)-(31)(g):

$$\begin{matrix}{p}_{1} = \frac{p}{6} + \frac{{α}^{2}}{2} - \frac{{β}^{2}}{6} + \frac{α}{3} & ( 31 ) ( a ) \\ {p}_{2} = \frac{p}{6} + \frac{1}{3} {β}^{2} + \frac{1}{\sqrt{3}} αβ + \frac{α}{6} + \frac{β}{2 \sqrt{3}} & ( 31 ) ( b ) \\ {p}_{3} = \frac{p}{6} + \frac{1}{3} {β}^{2} - \frac{1}{\sqrt{3}} αβ - \frac{α}{6} + \frac{β}{2 \sqrt{3}} & ( 31 ) ( c ) \\ {p}_{4} = \frac{p}{6} + \frac{{α}^{2}}{2} - \frac{{β}^{2}}{6} - \frac{α}{3} & ( 31 ) ( d ) \\ {p}_{5} = \frac{p}{6} + \frac{1}{3} {β}^{2} + \frac{1}{\sqrt{3}} αβ - \frac{α}{6} - \frac{β}{2 \sqrt{3}} & ( 31 ) ( e ) \\ {p}_{6} = \frac{p}{6} + \frac{1}{3} {β}^{2} - \frac{1}{\sqrt{3}} αβ + \frac{α}{6} - \frac{β}{2 \sqrt{3}} & ( 31 ) ( f )\end{matrix}$$

and the probability associated with the center of the descendent cell is given by EQUATION (31)(g):

p₇=(1−p)−(α²+β²); (31)(g)

and the probability parameter, p, must observe the following constraint:

½≦p≦⅔

Finally, if the derivative instrument is American, Cₙ₋₁^{k} is compared to

$$I ( {X}_{n - 1}^{k} )$$

and the greater of the two is stored.

This backward recursion will eventually lead to the root X₀ and the time 0, present state, value C (X₀0) of the derivative instrument, which is the price of the claim which is contingent on the underlying vector X₀ sought after.

It is worthy to note that if the procedure is left as described above, the seven children of all the nodes in the lattice will be determined twice—once on the way up while building the lattice and recording the nodes of the different time slices, and once on the way back while computing and storing values of the instrument. Thus, in an embodiment of the present invention, an economy can be realized on the way up if the forward build up of the lattice is limited to the boundaries of the successive time slices. In other words, in order to determine and record the nodes of the successive time slices, it is sufficient to determine and record the boundary nodes. (In general, children of boundary nodes will lie on the boundaries of the following time slice).

In sum, the philosophy behind the present invention is to determine, for each node in a time slice, the seven children nodes in the following time slice, such that the first and second moment equations are matched, and the probabilities are positive.

The lattice is first deformed (by the transformation matrix A) to match the first and second moment equations (EQUATIONS (17) and (18), respectively), with zero drift and the ground probability distribution. In this case, each node gets the hexagonal cell surrounding it (i.e., the natural descendant cell as children. Then the probabilities are modified to match the moment equations with non-zero drift. The greater the drift, the greater the modification of the probabilities.

However, these probabilities may turn negative. If the drift remains inside the “nucleus,” then the probabilities are positive with the children cell being the natural descendant cell.

If the drift is to be greater, then one has to select another descendant cell. This is designated as the cell inside whose nucleus this “abusive” drift lands. The creation process is prepared to modify the probabilities assigned to the natural cell in order to match this drift, but those probabilities were going to be negative. By having an alternative cell, the probabilities can be computed otherwise. This is accomplished by utilizing the alternative cell as though it were a natural descendant cell. That is, as far as the probabilities are concerned, the process proceeds as if the father node were transported to the center of the alternative cell. In other words, the process proceeds as if the drift was the vector joining the center of the alternative cell to the point of impact of the old drift. This is termed “cutting the drift.” The probabilities are then computed. At the end of the process, however, the “real” father node is still where it was—its children are vertices of the alternative cell (which is farther away than its natural descendant), and the probabilities are as computed.

VII. Details of Lattice Geometry—Three Dimensional Case

Having generally described the lattice creation process 900 and lattice traversal process 1000 above, a more detailed description is now given for the case where pricing a basket option which includes three underlying assets is desired.

A. Inputs

First, three underlying stochastic variables representing each asset in the basket are considered: x₁, x₂ and x₃. This comprises one underlying stochastic vector X:

$$X = ( \begin{matrix}{x}_{1} \\ {x}_{2} \\ {x}_{3}\end{matrix} )$$

The stochastic processes in the risk-neutral world are then given by:

dx₁=μ₁(X,t)dt+σ₁dz₁

dx₂=μ₂(X,t)dt+σ₂dz₂

dx₃=μ₃(X,t)dt+σ₃dz₃

With correlation coefficients:

ρ₁₂ between dz₁ and dz₂

ρ₁₃ between dz₁ and dz₃

ρ₂₃ between dz₂ and dz₃

The volatility parameters are:

σ₁σ₂σ₃

and the correlation coefficient are constant, but the drift vector is given by:

$$μ = ( \begin{matrix}{μ}_{1} \\ {μ}_{2} \\ {μ}_{3}\end{matrix} )$$

The drift Vector μ depends on both the state X and time t. The initial state at time zero (0) is:

$${X}_{0} = ( \begin{matrix}{x}_{1}^{0} \\ {x}_{2}^{0} \\ {x}_{3}^{0}\end{matrix} )$$

The present invention aims to price, at time t=0, a contingent claim C (i.e. a derivative instrument whose payoff is contingent upon the underlying vector X), of time to maturity T and payoff at maturity P(X). The price at time t=0, is denoted by C(X₀, 0). If the derivative instrument is an American-type option, its time t, state X, price C(X,t) must verify:

C(X,t)≧I(X)

Therefore, the inputs of the lattice building process are: (a) the diffusion parameters:

ρ_{1J}σ₁

(b) The complete drift function:

$$μ ( X , t ) = ( \begin{matrix}{μ}_{1} ( X , t ) \\ {μ}_{2} ( X , t ) \\ {μ}_{2} ( X , t )\end{matrix} )$$

(c) the initial value X₀ of the underlying state vector; (d) the value of the short interest rate r (or the interest rate term structure—yield curve or forward curve); (e) the number of time steps N one wishes to take; and (f) the probability parameters: ρ₁⁰ and ρ₂⁰.

Once N is fixed, the elementary time step is:

$$Δ t = \frac{T}{N}$$

B. Determination of the Geometry of the Elementary Cell

The elementary cell is a centered rhombic dodecahedron. However, it must be geometrically deformed in order to reflect the diffusion matrix:

$$\sum = ( \begin{matrix}{σ}_{1}^{2} & {ρ}_{12} {σ}_{1} {σ}_{2} & {ρ}_{13} {σ}_{1} {σ}_{3} \\ {ρ}_{12} {σ}_{1} {σ}_{2} & {σ}_{2}^{2} & {ρ}_{23} {σ}_{2} {σ}_{3} \\ {ρ}_{13} {σ}_{1} {σ}_{3} & {ρ}_{23} {σ}_{2} {σ}_{3} & {σ}_{3}^{2}\end{matrix} ) Δ t$$

The transformation matrix is:

$$A = \frac{1}{\sqrt{\frac{4}{3} {p}_{1}^{0} + {p}_{2}^{0}}} P \sqrt{Λ}$$

where

Σ=PAP*

That is:

$$Λ = ( \begin{matrix}{λ}_{1} & 0 & 0 \\ 0 & {λ}_{2} & 0 \\ 0 & 0 & {λ}_{3}\end{matrix} )$$

is the matrix of eigenvalues of S, and P the matrix of eigenvectors, which are computed by standard techniques as will be apparent to one skilled in the relevant art(s). The “*” is for the transpose of a matrix.

The lattice, that is the set of states (or nodes):

$$X = ( \begin{matrix}{x}_{1} \\ {x}_{2} \\ {x}_{3}\end{matrix} )$$

is a deformed rhombic dodecahedral lattice. It is the aim to retain it for the discretization. However, we define a straight computational lattice E where coordinates of the nodes have integer values and correspond one to one to the real, “physical” nodes:

$$E = ( \begin{matrix}{i}_{1} \\ {i}_{2} \\ {i}_{3}\end{matrix} ) ↔ X = ( \begin{matrix}{x}_{1} \\ {x}_{2} \\ {x}_{3}\end{matrix} )$$

through the transformation:

$$X = ( \begin{matrix}{x}_{1} \\ {x}_{2} \\ {x}_{3}\end{matrix} ) = A ( \begin{matrix}{i}_{1} \\ {i}_{2} \\ {i}_{3}\end{matrix} )$$

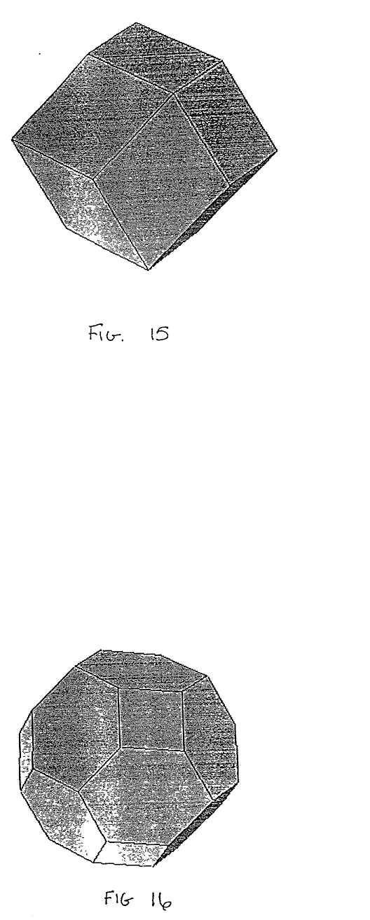

Indeed, in the computational plane, the rhombic dodecahedron is represented as shown in FIG. 15, with its vertices having the following integer coordinates:

$${H}_{0}^{dodeca} = ( \begin{matrix}2 & 0 & 0 & 1 & 1 & - 1 & 1 & 0 & - 2 & 0 & 0 & - 1 & - 1 & 1 & - 1 & 0 \\ 0 & 2 & 0 & 1 & - 1 & 1 & 1 & 0 & 0 & - 2 & 0 & - 1 & 1 & - 1 & - 1 & 0 \\ 0 & 0 & 2 & 1 & 1 & 1 & - 1 & 0 & 0 & 0 & - 2 & - 1 & - 1 & - 1 & 1 & 0\end{matrix} )$$

and being numbered:

(1 2 3 4 5 6 7 8 1′ 2′ 3′ 4′ 5′ 6′ 7′ 8′)

One will note that, in an embodiment of the present invention, the center node has been counted twice for symmetry reasons.

C. Building of the Lattice

The building of the lattice is a recursive procedure running forward in time. It starts with the origin (or root):

$${X}_{0} = ( \begin{matrix}{x}_{1}^{0} \\ {x}_{2}^{0} \\ {x}_{3}^{0}\end{matrix} )$$

and progressively “marks”, for each time slice n (0≦n≦N), the nodes of the computational lattice E which will belong to this time slice. It is the drift function that will of course govern this process.

The recursive mechanism is the following:

If nodes of time slice n−1 are:

Eₙ₋₁={Eₙ₋₁^{k}}_{1≦k≦k}_{ₙ₋₁}

where Kₙ₋₁ is their number, the following steps (a)-(d) are performed:

(a) for each node Eₙ₋₁^{k}, find its physical correspondent Xₙ₋₁^{k} by computing:

Eₙ₋₁^{k}=X₀+AEₙ₋₁^{k}

$$( This means the root {X}_{0} has the \\ computational correspondent {E}_{0} = ( \begin{matrix}0 \\ 0 \\ 0\end{matrix} ) . )$$

(b) Compute the drift vector at Xₙ₋₁^{k} by computing:

$$μ ( {X}_{n - 1}^{k} , ( n - 1 ) Δ t ) = ( \begin{matrix}{μ}_{1} ( {X}_{n - 1}^{k} , ( n - 1 ) Δ t ) \\ {μ}_{2} ( {X}_{n - 1}^{k} , ( n - 1 ) Δ t ) \\ {μ}_{3} ( {X}_{n - 1}^{k} , ( n - 1 ) Δ t )\end{matrix} ) Δ t$$

(c) The drift vector sends us to a point Zₙ₋₁^{k} somewhere in the physical plane:

Zₙ₋₁^{k}=Xₙ₋₁^{k}+μₙ₋₁^{k}

and the aim becomes to determine the node of the lattice that is “closest” (as explained herein) to Zₙ₋₁^{k}. This is called the “target” node.

Yₙ₋₁^{k} is the candidate node for occupying the center of the cell of descendants of Xₙ₋₁^{k}. Meaning, once we determine Yₙ₋₁^{k}, the fourteen other children nodes of Xₙ₋₁^{k} will be determined as well, as vertices of the rhombic dodecahedron surrounding Yₙ₋₁^{k}.

The determining criterion is that the point where the drift sends us, Zₙ₋₁^{k}, lie in the nucleus of the target cell. The nucleus of the rhombic dodecahedron is the solid called Lord Kelvin's solid and shown in FIG. 16. That is, Yₙ₋₁^{k} must the be the center of the rhombic dodecahedron in whose nucleus Zₙ₋₁^{k} lies.

Calling

$$( \begin{matrix}{z}_{1} \\ {z}_{2} \\ {z}_{3}\end{matrix} )$$

the physical coordinates of Zₙ₋₁^{k}, its coordinates in the computational plane are:

$$e = ( \begin{matrix}{e}_{1} \\ {e}_{2} \\ {e}_{3}\end{matrix} ) = {A}^{- 1} ( \begin{matrix}{z}_{1} - {x}_{1}^{0} \\ {z}_{2} - {x}_{2}^{0} \\ {z}_{3} - {x}_{3}^{0}\end{matrix} )$$

These will not generally be integer values, so Yₙ₋₁^{k} will be the one among the nodes of the computational space which is closest to Zₙ₋₁^{k}. “Closest” here means “closest in terms of Euclidian distance” as measured in computational space.

The selected minimizer ƒ will then represent the coordinates in the computational plane of the target node Yₙ₋₁^{k}. As for the fourteen other children, their coordinates in the computational plane will be given by:

$$f + ( \begin{matrix}2 & 0 & 0 & 1 & 1 & - 1 & 1 & - 2 & 0 & 0 & - 1 & - 1 & 1 & - 1 \\ 0 & 2 & 0 & 1 & - 1 & 1 & 1 & 0 & - 2 & 0 & - 1 & 1 & - 1 & - 1 \\ 0 & 0 & 2 & 1 & 1 & 1 & - 1 & 0 & 0 & - 2 & - 1 & - 1 & - 1 & 1\end{matrix} )$$

(d) Repeating this procedure for each one of Eₙ₋₁^{k} and discarding repetitions, will give us the list of the nodes of the computational lattice which will constitute time slice n:

$${E}_{n} = {\{ {E}_{n}^{k} \}}_{1 \leq k \leq {K}_{n}} = {⋃}_{1 \leq k \leq {K}_{n - 1}} \{ fifteen children of {E}_{n - 1}^{k} \}$$

D. Traversing the Lattice

When building of the lattice is completed, a record for each time slice of the nodes constituting the lattice is obtained. In particular, the complete list of nodes of the last time slice N is now available:

E_{N}={E_{N}^{k}}_{1≦k≦K}_{_{N}}

The payoff of the derivative instrument is then computed at this last time slice. For each one of the nodes, find its physical coordinates through:

X_{N}^{k}=X₀+AE_{N}^{k}

and compute the corresponding payoff P(X_{N}^{k}). This is the value of the derivative instrument which will be stored in time slice N at node E_{N}^{k}.

Rolling back in the tree will then inductively takes place as follows. First, assuming values of the derivative instrument have been computed and stored at all nodes Eₙ^{k} of time slice n, step back to time slice n−1. In the list of nodes, the following is already stored:

Eₙ₋₁={Eₙ₋₁^{k}}_{1≦k≦K}_{_{N-1}}

Thus, for each one of the nodes Eₙ₋₁^{k} in the list of nodes (whose physical equivalent is Xₙ₋₁^{k}), find its fifteen children nodes in the same fashion as while building the lattice (in particular find node Yₙ₋₁^{k} occupying the center of the descendent cell). The children will have to figure among the {Eₙ^{k}}_{1≦k≦k}_{ₙ} (this is what building the lattice is meant to insure).

Retrieve the values (Cₙ¹)_{1≦i≦7} of the derivative instrument that have been previously stored in these seven nodes. Next, the drift μₙ₋₁^{k} is cut by the displacement between Xₙ₋₁^{k} and Yₙ₋₁^{k}:

μₙ₋₁^{k}=μₙ₋₁^{k}−(Yₙ₋₁^{k}−Xₙ₋₁^{k})

(all this is done in the physical space).

Then, decompose the residual drift on the transformed basis to get

$$( \begin{matrix}α \\ β \\ γ\end{matrix} ) ,$$

where:

$$( \begin{matrix}α \\ β \\ γ\end{matrix} ) = {A}^{- 1} {μ}_{n - 1}^{k}$$

The value of the derivative instrument which is to be stored in time slice n−1 at node Eₙ₋₁^{k} is first evaluated as:

$${C}_{n - 1}^{k} = {e}^{- {r}_{n - 1}^{1} Δ t} {\sum }_{1 \leq i \leq 15} {p}_{i} {C}_{n}^{i}$$

where rₙ₋₁^{k} is the instantaneous interest rate prevailing at node Xₙ₋₁^{k} in time slice n−1. (If the short rate is among the underlying stochastic variables, rₙ₋₁^{k} will be one of the components of Xₙ₋₁^{k}, otherwise it is uniform within the same time slice and equal to the forward rate as given by the initial input of the forward curve.)

(p₁)_{1≦i≦15} are the guaranteed positive, risk-neutral probabilities (i.e., the probabilities that ensure that first and second moment equations of the risk-neutral stochastic processes given above are matched at each node). If the fifteen children nodes are listed in the same order as the coordinates of the rhombic dodecahedron above, computing the probabilities proceeds in two stages.

It is first assumed that (α, β, γ) has all three positive components and that γ≧α≧β. The sums of probabilities assigned to symmetrical nodes are then expressed as follows (i.e., πᵢ=ρᵢ+ρᵢ):

$${π}_{1} = \frac{{p}_{1}^{0}}{3} + {λα}^{2} + θ ( {β}^{2} + {γ}^{2} )$$

$${π}_{2} = \frac{{p}_{1}^{0}}{3} + {λβ}^{2} + θ ( {α}^{2} + {γ}^{2} )$$

$${π}_{3} = \frac{{p}_{1}^{0}}{3} + {λγ}^{2} + θ ( {α}^{2} + {β}^{2} )$$

$${π}_{4} = \frac{{p}_{2}^{0}}{4} + η ( {α}^{2} + {β}^{2} + {γ}^{2} ) + ϕ ( αβ + αγ + βγ )$$

$${π}_{5} = \frac{{p}_{2}^{0}}{4} + η ( {α}^{2} + {β}^{2} + {γ}^{2} ) + ϕ ( - αβ + αγ - βγ )$$

$${π}_{6} = \frac{{p}_{2}^{0}}{4} + η ( {α}^{2} + {β}^{2} + {γ}^{2} ) + ϕ ( - αβ - αγ + βγ )$$

$${π}_{7} = \frac{{p}_{2}^{0}}{4} + η ( {α}^{2} + {β}^{2} + {γ}^{2} ) + ϕ ( αβ - αγ - βγ )$$

$${π}_{8} = {p}_{3}^{0} + ρ ( {α}^{2} + {β}^{2} + {γ}^{2} )$$

(π₈ is the probability attached to the center.); where:

$$λ = - η + \frac{1}{4}$$

$$θ = - η$$

$$ϕ = \frac{1}{4}$$

$$ρ = - η - \frac{1}{4}$$

and observing the following constraints:

$$η \leq \frac{11}{80} - \frac{{p}_{2}^{0}}{5}$$

$$0 \leq {p}_{2}^{0} \leq \frac{1}{16}$$

$$\frac{1}{8} \leq η \leq \frac{11}{80} - \frac{{p}_{2}^{0}}{5}$$

$$\frac{15}{32} \leq {p}_{1}^{0} \leq \frac{17}{32} - {p}_{2}^{0}$$

$$\frac{15}{32} \leq {p}_{3}^{0} \leq \frac{17}{32} - {p}_{2}^{0}$$

$${p}_{3}^{0} = 1 - {p}_{1}^{0} - {p}_{2}^{0} ; and$$

the individual probabilities will then be expressed by:

$${p}_{1} = \frac{{π}_{1}}{2} + {ω}_{1 } and {p}_{i}^{′} = \frac{{π}_{i}}{2} - {ω}_{i}$$

where:

ω₁=aα

ω₂=aβ

ω₃=aγ

ω₄=b(α+β+γ)

ω₅=b(α−β+γ)

ω₆=b(−α+β+γ)

ω₇=b(α+β−γ)

and

$$2 a + 4 b = \frac{1}{2}$$

The strategy of the present invention then consists in fixing the remaining parameters, for instance:

$$η = \frac{1}{8}$$

$${p}_{1}^{0} = \frac{15}{4} η = \frac{15}{32}$$

$${p}_{2}^{0} = \frac{1}{16}$$

$${p}_{3}^{0} = \frac{15}{32}$$

a=0, so that b=⅛

The above gives a temporary expression of the individual probabilities. If they are all positive, then computation of the probabilities at the node is complete. Otherwise, to finalize the expression of probabilities (i.e., in order to make sure the probabilities are positive), each probability must be shifted by an amount dp, which is computed as follows:

-if, for j ε{4,5,6}, one of the \tilde{p}′ⱼ is negative, set:

$${dp}_{j}^{′} = {\tilde{p}}_{J}^{′}$$

(i.e., bring the negative probability back to zero)

dpⱼ=\tilde{p}′ⱼ

(i.e., maintain constant the sums of conjugate probabilities)

Otherwise, dp′ⱼ=dpⱼ=0

Then, set:

dp₇=−\tilde{p}₇

dp′₇=\tilde{p}₇

and finally, calculate:

$${dp}_{1} = \frac{- {dp}_{4} - {dp}_{5} + {dp}_{6} - {dp}_{7}}{2}$$

$${dp}_{2} = \frac{- {dp}_{4} + {dp}_{5} - {dp}_{6} - {dp}_{7}}{2}$$

$${dp}_{3} = \frac{- {dp}_{4} - {dp}_{5} - {dp}_{6} + {dp}_{7}}{2}$$

and

$${( {dp}_{j}^{′} = - {dp}_{J} )}_{j ∈ \{ 1 , 2 , 3 \}} .$$

The probability at the center node is left untouched.

In the event that our first assumption is not true (i.e., all three components of

$$( \begin{matrix}α \\ β \\ γ\end{matrix} )$$

are not positive and that the expression γ≧α≧β is not true), it is recalled that the vertices of the rhombic dodecahedron (with the center node counted twice) and they are now numbered in the following fashion:

$${H}_{0}^{dodeca} = ( \begin{matrix}2 & 0 & 0 & 1 & 1 & - 1 & 1 & 0 & - 2 & 0 & 0 & - 1 & - 1 & 1 & - 1 & 0 \\ 0 & 2 & 0 & 1 & - 1 & 1 & 1 & 0 & 0 & - 2 & 0 & - 1 & 1 & - 1 & - 1 & 0 \\ 0 & 0 & 2 & 1 & 1 & 1 & - 1 & 0 & 0 & 0 & - 2 & - 1 & - 1 & - 1 & 1 & 0\end{matrix} )$$

And we now number them in the following fashion:

(1 2 3 4 5 6 7 8 9 10 11 12 13 14 15 16)

Now, prob is defined to be the array of probabilities as assigned to the vertices in this order (splitting in two the probability for the two twin-center nodes). Then the following eight transformations are defined (using pseudo-code) as follows:

| | |
|---|---|
| salpha(prob); | sbeta(prob); |
| let probtemp=prob; | let probtemp=prob; |
| then reshuffle thus: | then reshuffle thus: |
| prob[1]=probtemp[9]; | prob[1]=probtemp[1]; |
| prob[2]=probtemp[2]; | prob[2]=probtemp[10]; |
| prob[3]=probtemp[3]; | prob[3]=probtemp[3]; |
| prob[4]=probtemp[6]; | prob[4]=probtemp[5]; |
| prob[5]=probtemp[15]; | prob[5]=probtemp[4]; |
| prob[6]=probtemp[4]; | prob[6]=probtemp[15]; |
| prob[7]=probtemp[13]; | prob[7]=probtemp[14]; |
| prob[9]=probtemp[1]; | prob[9]=probtemp[9]; |
| prob[10]=probtemp[10]; | prob[10]=probtemp[2]; |
| prob[11]=probtemp[11]; | prob[11]=probtemp[1]; |
| prob[12]=probtemp[14]; | prob[12]=probtemp[13]; |
| prob[13]=probtemp[7]; | prob[3]=probtemp[12]; |
| prob[14]=probtemp[12]; | prob[14]=probtemp[7]; |
| prob[15]=probtemp[5]; | prob[15]=probtemp[6]; |
| return=(prob); | return=(prob); |
| sgam(prob); | salbeta(prob); |
| let probtemp=prob; | let probtemp=prob; |
| then reshuffle thus: | then reshuffle thus; |
| prob[1]=probtemp[1]; | prob[1]=probtemp[2]; |
| prob[2]=probtemp[2]; | prob[2]=probtemp[1]; |
| prob[3]=probtemp[11]; | prob[3]=probtemp[3]; |
| prob[4]=probtemp[7]; | prob[4]=probtemp[4]; |
| prob[5]=probtemp[14]; | prob[5]=probtemp[6]; |
| prob[6]=probtemp[13]; | prob[6]=probtemp[5]; |
| prob[7]=probtemp[4]; | prob[7]=probtemp[7]; |
| prob[9]=probtemp[9]; | prob[9]=probtemp[10]; |
| prob[10]=probtemp[10]; | prob[10]=probtemp[9]; |
| prob[11]=probtemp[3]; | prob[11]=probtemp[11]; |
| prob[12]=probtemp[15]; | prob[12]=probtemp[12]; |
| prob[13]=probtemp[6]; | prob[13]=probtemp[14]; |
| prob[14]=probtemp[5]; | prob[14]=probtemp[13]; |
| prob[15]=probtemp[12]; | prob[15]=probtemp[15]; |
| return(prob); | return(prob); |
| sbetagam(prob); | salgam(prob); |
| let probtemp=prob; | let probtemp=prob; |
| then reshuffle thus: | then reshuffle thus: |
| prob[1]=probtemp[1]; | prob[1]=probtemp[3]; |
| prob[2]=probtemp[3]; | prob[2]=probtemp[2]; |
| prob[3]=probtemp[2]; | prob[3]=probtemp[1]; |
| prob[4]=probtemp[4]; | prob[4]=probtemp[4]; |
| prob[5]=probtemp[7]; | prob[5]=probtemp[5]; |
| prob[6]=probtemp[6]; | prob[6]=probtemp[7]; |
| prob[7]=probtemp[5]; | prob[7]=probtemp[6]; |
| prob[9]=probtemp[9]; | prob[9]=probtemp[11]; |
| prob[10]=probtemp[11]; | prob[10]=probtemp[10]; |
| prob[11]=probtemp[10]; | prob[11]=probtemp[9]; |
| prob[12]=probtemp[12]; | prob[12]=probtemp[12]; |
| prob[13]=probtemp[15]; | prob[13]=probtemp[13]; |
| prob[14]=probtemp[14]; | prob[14]=probtemp[15]; |
| prob[15]=probtemp[13]; | prob[15]=probtemp[14]; |
| return(prob); | return(prob); |
| rotpos(prob); | rotneg(prob); |
| let probtemp=prob; | let probtemp=prob; |
| then reshuffle thus: | then reshuffle thus: |
| prob[1]=probtemp[2]; | prob[1]=probtemp[3] |
| prob[2]=probtemp[3]; | prob[2]=probtemp[1]; |
| prob[3]=probtemp[1]; | prob[3]=probtemp[2]; |
| prob[4]=probtemp[4]; | prob[4]=probtemp[4]; |
| prob[5]=probtemp[7]; | prob[5]=probtemp[6]; |
| prob[6]=probtemp[5]; | prob[6]=probtemp[7]; |
| prob[7]=probtemp[6]; | prob[7]=probtemp[5]; |
| prob[9]=probtemp[10]; | prob[9]=probtemp[11]; |
| prob[10]=probtemp[11]; | prob[10]=probtemp[9]; |
| prob[11]=probtemp[9]; | prob[11]=probtemp[10]; |
| prob[12]=probtemp[12]; | prob[12]=probtemp[12]; |
| prob[13]=probtemp[15]; | prob[13]=probtemp[14]; |
| prob[14]=probtemp[13]; | prob[14]=probtemp[15]; |
| prob[15]=probtemp[14]; | prob[15]=probtemp[13]; |
| return(prob); | return(prob); |

The above eight transformations allow probabilities within the same array to be permutated. Now, any one of the components of

$$( \begin{matrix}α \\ β \\ γ\end{matrix} )$$

can be negative, and thus must be so marked. Thus, a marker-variable is initialized, case=0, and the following logic is performed:

if α<0, set α=−α and case=case+1;

if β<0, set β=−β and case=case+10;

if γ<0, set γ=−γ and case=case+100;

This allows a fall back to the case of three positive components, and the marker-variable indicates how this was achieved. For instance, if case exits with the value 101: this indicates that the sign of alpha and gamma were changed. Likewise, a value of 111 indicates the sign of alpha, beta and gamma were changed, and so forth.

Therefore, the above results in three positive components which fall into one of the following six cases, which are processed as follows:

### Case 1

If (α≧β≧γ), then permute the three components in order to fall back to the case where γ≧α≧β. In other words, set γ=α; α=β; and β=γ:

The process for computing the guaranteed positive individual probabilities, as given above, can then be applied. However, reassignment of the probabilities to a permutation of the nodes of the rhombic dodecahedron is required. This is done as follows:

if case==0;
prob=rotneg(prob);
elseif case==1;
prob=salpha(rotneg(prob));
elseif case==10;
prob=sbeta(rotneg(prob));
elseif case==100;
prob=sgam(rotneg(prob));
elseif case==11;
prob=salpha(sbeta(rotneg(prob)));
elseif case==101;
prob=salpha(sgam(rotneg(prob)));
elseif case==110;
prob=sbeta(sgam(rotneg(prob)));
elseif case==111;
prob=salpha(sbeta(sgam(rotneg(prob))));
endif.

### 2. Case 2

If (α≧γ≧β), then set γ=α; and α=γ. The array of probabilties is computed and then:

if case==0;
prob=salgam(prob);
elseif case==1;
prob=salpha(salgam(prob));
elseif case==10;
prob=sbeta(salgam(prob));
elseif case==100;
prob=sgam(salgam(prob));
elseif case==11;
prob=salpha(sbeta(salgam(prob)));
elseif case==101;
prob=salpha(sgam(salgam(prob)));
elseif case==110;
prob=sbeta(sgam(salgam(prob)));
elseif case==111;
prob=salpha(sbeta(sgam(salgam(prob))));
endif.

### 3. Case 3

If (β≧α≧γ), then set γ=β; and β=γ: The array of probabilities is computed, and then:

if case==0;
prob=sbetagam(prob);
elseif case==1;
prob=salpha(sbetagam(prob));
elseif case==10;
prob=sbeta(sbetagam(prob));
elseif case==100;
prob=sgam(sbetagam(prob));
elseif case==11;
prob=salpha(sbeta(sbetagam(prob)));
elseif case==101;
prob=salpha(sgam(sbetagam(prob)));
elseif case==110;
prob=sbeta(sgam(sbetagam(prob)));
elseif case==111;
prob=salpha(sbeta(sgam(sbetagam(prob))));
endif.

### 4. Case 4

If (β≧γ≧α), then set γ=β; α=γ; and β=α. The array of probabilities is computed, and then:

if case==0;
prob=rotpos(prob);
elseif case==1;
prob=salpha(rotpos(prob));
elseif case==10;
prob=sbeta(rotpos(prob));
elseif case==100;
prob=sgam(rotpos(prob));
elseif case==11;
prob=salpha(sbeta(rotpos(prob)));
elseif case==101;
prob=salpha(sgam(rotpos(prob)));
elseif case==110;
prob=sbeta(sgam(rotpos(prob)));
elseif case==111;
prob=salpha(sbeta(sgam(rotpos(prob))));
endif.

### 5. Case 5

If (γ≧α≧β), then compute the array of probabilities, and then:

if case==1;
prob=salpha(prob);
elseif case==10;
prob=sbeta(prob);
elseif case==100;
prob=sgam(prob);
elseif case==11;
prob=salpha(sbeta(prob));
elseif case==101;
prob=salpha(sgam(prob));
elseif case==110;
prob=sbeta(sgam(prob));
elseif case==111;
prob=salpha(sbeta(sgam(prob)));
endif.

### 6. Case 6

If, (γ≧β≧α), then set α=β; and β=α. The array of probabilities is computed, and then:

if case==0;
prob=salbeta(prob);
elseif case==1;
prob=salpha(salbeta(prob));
elseif case==10;
prob=sbeta(salbeta(prob));
elseif case==100;
prob=sgam(salbeta(prob));
elseif case==11;
prob=salpha(sbeta(salbeta(prob)));
elseif case==101;
prob=salpha(sgam(salbeta(prob)));
elseif case==110;
prob=sbeta(sgam(salbeta(prob)));
elseif case==111;
prob=salpha(sbeta(sgam(salbeta(prob))));
endif.

This completes the computation of the individual probabilities assigned to the rhombic dodecahedral vertices in all cases where

$$( \begin{matrix}α \\ β \\ γ\end{matrix} )$$

lies in the nucleus.

Finally, if the derivative instrument is an American-type, Cₙ₋₁^{k} is compared to I(Xₙ₋₁^{k}) and we store the greater of the two. This backward recursion will eventually lead us to the root X₀ and the time 0, present state, value C(X₀, 0) of the derivative instrument, which is the theoretical price sought by the present invention.

If the embodiment described above is left as is, the fifteen children of all the nodes in the lattice will be determined twice over—once on our way up while building the lattice and recording the nodes of the different time slices, and once on the way back while computing and storing values of the instrument. An economy can be realized, in an embodiment of the present invention, on the way up. If the forward build up of the lattice is limited to the boundaries of the successive time slices. In other words, in order to determine and record the nodes of the successive time slices, it is sufficient to determine and records the boundary nodes. (In general, children of boundary nodes will lie on the boundaries of the following time slice.)

VIII. Computational Efficiency of the Present Invention

As mentioned above with reference to TABLE 1, the present invention extends Hull and White's trinomial technique to obtain the most economical and efficient lattice discretization for higher dimensional Brownian motions of the most general form (i.e., EQUATION (14)). More specifically, consider the two-and three-dimensional cases.

In the two-dimension case (i.e., a basket option with two assets underlying it), the hexagonal lattice is the optimal two-dimensional lattice because there is no way of further reducing the number of nodes in the elementary cell, and the number of nodes of the T^{th} slice will here be:

(3T²+3T+1)

as opposed to:

(4T²+4T+1)

in the Hull and White tensor product lattice. This gain is significant, but not as significant as in the three-dimensional case described below. Nevertheless, computing time reduced not only because the backward recursion has to read much less nodes in each time slice where the prices of the option are computed, but also because the computation of each single price—as discounted expected value of prices in descendant nodes—will require less calls of previously computed prices (7 instead of 9 as highlighted in TABLE 1).

In the three-dimensional case (i.e., a basket option with three assets underlying it), the number of nodes in the T^{th} time slice is:

(2T+1)(2T²+2T+1)

For example, at the second time slice, 65 nodes are present in the rhombic dodecahedral lattice as shown in FIG. 13. Despite its apparent complexity, the lattice is in fact simpler than the traditional grid. More specifically, the number of nodes in the case of the Hull and White trinomial tensor product is:

(2T+1)(4T²+4T+1)

The ratio to the present invention is:

$$\frac{1}{2} + \frac{1}{2 ( 4 {T}^{2} + 4 T + 1 )}$$

and converges rapidly to one-half. Bearing in mind that the number of nodes in a cell (15) is almost half the number of nodes of the tensor product cell (27) (as highlighted in TABLE 1), the gain in computing time is then approximately fourfold.

IX. Example Implementations

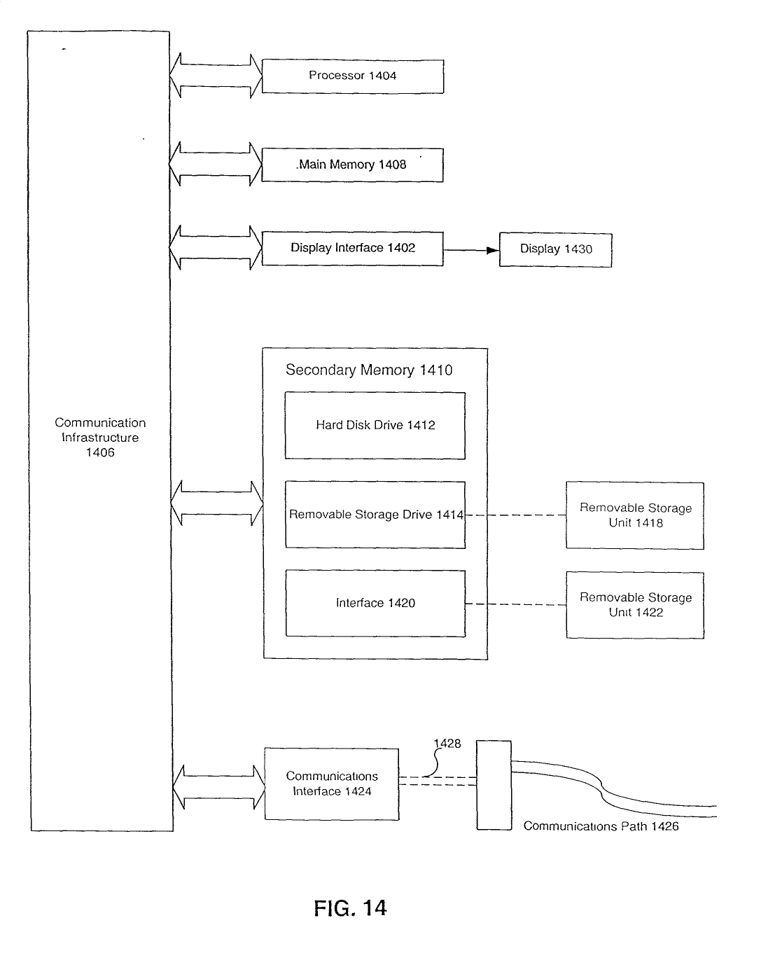

The present invention (e.g., lattice creation process 900, lattice traversal process 1000, or any part thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 1400 is shown in FIG. 14. The computer system 1400 includes one or more processors, such as processor 1404. The processor 1404 is connected to a communication infrastructure 1406 (e.g., a communications bus, cross-over bar, or network). Various software embodiments are described in terms of this exemplary computer system. After reading this description, it will become apparent to a person skilled in the relevant art how to implement the invention using other computer systems and/or computer architectures.

Computer system 1400 can include a display interface 1405 that forwards graphics, text, and other data from the communication infrastructure 1402 (or from a frame buffer not shown) for display on the display unit 1430.

Computer system 1400 also includes a main memory 1408, preferably random access memory (RAM), and may also include a secondary memory 1410.

The secondary memory 1410 may include, for example, a hard disk drive 1412 and/or a removable storage drive 1414, representing a floppy disk drive, a magnetic tape drive, an optical disk drive, etc. The removable storage drive 1414 reads from and/or writes to a removable storage unit 1418 in a well-known manner. Removable storage unit 1418, represents a floppy disk, magnetic tape, optical disk, etc. which is read by and written to by removable storage drive 1414.

As will be appreciated, the removable storage unit 1418 includes a computer usable storage medium having stored therein computer software and/or data.

In alternative embodiments, secondary memory 1410 may include other similar means for allowing computer programs or other instructions to be loaded into computer system 1400. Such means may include, for example, a removable storage unit 1422 and an interface 1420. Examples of such may include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

Computer system 1400 may also include a communications interface 1424. Communications interface 1424 allows software and data to be transferred between computer system 1400 and external devices. Examples of communications interface 1424 may include a modem, a network interface (such as an Ethernet card), a communications port, a PCMCIA slot and card, etc. Software and data transferred via communications interface 1424 are in the form of signals 1428 which may be electronic, electromagnetic, optical or other signals capable of being received by communications interface 1424. These signals 1428 are provided to communications interface 1424 via a communications path (i.e., channel) 1426. This channel 1426 carries signals 1428 and may be implemented using wire or cable, fiber optics, a phone line, a cellular phone link, an RF link and other communications channels.

In this document, the terms “computer program medium” and “computer usable medium” are used to generally refer to media such as removable storage drive 1414, a hard disk installed in hard disk drive 1412, and signals 1428. These computer program products are means for providing software to computer system 1400. The invention is directed to such computer program products.

Computer programs (also called computer control logic) are stored in main memory 1408 and/or secondary memory 1410. Computer programs may also be received via communications interface 1424. Such computer programs, when executed, enable the computer system 1400 to perform the features of the present invention as discussed herein. In particular, the computer programs, when executed, enable the processor 1404 to perform the features of the present invention. Accordingly, such computer programs represent controllers of the computer system 1400.

In an embodiment where the invention is implemented using software, the software may be stored in a computer program product and loaded into computer system 1400 using removable storage drive 1414, hard drive 1412 or communications interface 1424. The control logic (software), when executed by the processor 1404, causes the processor 1404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

X. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

[image]

[image]

[image]

[image]

[image]

[image]

[image]

[image]

[image]

[image]

[image]

[image]

[image]

[image]

[image]

[image]

[image]

[image]

What is claimed is:

1. A method for pricing the current value of a basket option consisting of a plurality of underlying assets, comprising the steps of:
(1) receiving an input indicative of the spot value for each of the plurality of underlying assets within the basket option;
(2) receiving an input indicative of the risk free interest rate;
(3) receiving an input indicative of the diffusion parameters for the option;
(4) receiving an input indicative of the desired number of time slices;
(5) receiving an input indicative of the maturity date of the option;
(6) building a lattice, using said inputs from steps (1)-(5), wherein the lattice is comprised of an elementary cell structure for each of said time slices; and
(7) traversing, in a backwards fashion, said lattice in order to calculate the value of the basket option from said maturity date to the present.

2. The method of claim 1, wherein the plurality of assets includes exactly two assets and said elementary cell structure is a hexagon.

3. The method of claim 1, wherein the plurality of assets includes exactly three assets and said elementary cell structure is a rhomba-dodecahedron.

4. The method of claim 1, wherein the plurality of assets includes exactly n assets and the number of sides of the shape of said elementary cell structure is given by the equation: (2ⁿ⁺¹)−2.

5. The method of claim 1, wherein step (1) comprises the steps of:
(a) receiving an input indicative of the correlation, ρ, of each asset to each other asset within the plurality of underlying assets; and
(b) receiving an input indicative of the volatility, σ, of each of the plurality of underlying assets.

6. A computer program product comprising a computer usable medium having control logic stored therein for causing a computer to price the current value of a basket option consisting of a plurality of underlying assets, said control logic comprising:
a first computer readable program code means for causing the computer to receive an input indicative of the spot value for each of the plurality of underlying assets within the basket option;
a second computer readable program code means for causing the computer to receive an input indicative of the risk free interest rate;
a third computer readable program code means for causing the computer to receive an input indicative of the diffusion parameters for the option;
a fourth computer readable program code means for causing the computer to receive an input indicative of the desired number of time slices;
a fifth computer readable program code means for causing the computer to receive an input indicative of the maturity date of the option;
a sixth computer readable program code means for causing the computer to build a lattice, using said inputs from said first, second, third, fourth, and fifth computer readable program code means, wherein the lattice is comprised of an elementary cell structure for each of said time slices; and
a seventh computer readable program code means for causing the computer to traverse, in a backwards fashion, said lattice in order to calculate the value of the basket option from said maturity date to the present.
